(19) United States
(12) Patent Application Publication
(10) Pub. No.: US 2025/0015401 A1
(43) Pub. Date: Jan. 9, 2025

(54) ENERGY SUPPLY DEVICE HAVING A CELL WITHOUT A PRESSURE RELIEF VALVE AND POWER TOOL HAVING SUCH AN ENERGY SUPPLY DEVICE

(71) Applicant: Hilti Aktiengesellschaft, Schaan (LI)

(72) Inventors: Robert STANGER, Kaufbeuren (DE); Andreas GUGGEMOS, Bad Woerishofen (DE); Sabrina MÜLLER, Moorenweis (DE)

(21) Appl. No.: 18/709,549

(22) PCT Filed: Nov. 10, 2022
(86) PCT No.: PCT/EP2022/081492

§ 371 Date: May 13, 2024

(30) Foreign Application Priority Data
Dec. 1, 2021 (EP) 21211580.2

(51) Int. Cl. H01M 50/136; H01M 50/143; H01M 50/238; H01M 50/242

(52) U.S. Cl. CPC H01M 50/136; H01M 50/143; H01M 50/238; H01M 50/242; H01M 2220/30

(57) ABSTRACT

An energy supply device, in particular for a power tool, wherein the energy supply device includes at least one cell and wherein at least one cell of the energy supply device has no pressure relief valve. Moreover, the at least one cell can have a flexible outer shell, at least in some section or sections or some region or regions. The at least one cell can have an outer surface or a volume, wherein a size of the outer surface or of the volume can be changed in accordance with cell parameters. In a second aspect, the invention relates to a power tool having a proposed energy supply device.

The present invention relates to an energy supply device, in particular for a power tool, wherein the energy supply device comprises at least one cell. In a second aspect, the invention relates to a power tool having an energy supply device.

### BACKGROUND OF THE INVENTION

The invention is situated in the technical field of power tools. In this technical field, increasing use is being made of cordless power tools, which are supplied with electrical energy or current by means of energy supply devices, such as storage batteries or rechargeable batteries. The energy supply devices of the power tools usually have battery packs with cells which are inexpensive to produce and can be produced in standardized sizes. Such cells can have various basic shapes, the cells generally having rigid, nondeformable outer walls. The cells of conventional energy supply devices, of the kind known from the prior art, usually have a pressure-based pressure relief valve, which is frequently of two-stage design. In English, the term “current interruptive devices” (CID) is used for such pressure relief valves. The pressure relief valve of the cells is designed to deactivate the cells automatically in certain situations considered to be critical. This can be accomplished, for example, by switching the cells to a high resistance. In a second step of deactivating the cell, the cell can be opened by the pressure relief valve in order to discharge or reduce an internal pressure of the cell.

### SUMMARY OF THE INVENTION

In the case of some cells with rigid outer walls, bursting of the cell outer walls is observed if unwanted chemical reactions and processes or temperature fluctuations occur within the cell. Cases in which cells have been damaged in the region of the pressure relief valve have also been known. An energy supply device having such a defective cell is unsuitable for use in a power tool and must be disposed of at some expense.

For example, US 2004 146 777 A1 discloses an electrochemical device, the electrochemical device comprising a sealed boundary, which can be designed to be partially flexible.

EP 3 651 227 A1 and US 2012 040 235 A1 describe batteries with a bag-type battery housing.

WO 2011 051 174 A1 discloses a battery cell having a housing, wherein the housing has two different subregions. When an internal pressure in the first subregion increases, a fluid can flow from the first subregion into the second subregion.

US 2004 175 609 A1 describes a battery and a stacked battery arrangement, wherein the battery has a deformable housing with a buffer for accumulating gas within the housing.

In the case of power tools which are used, for example, for heavy work on a construction site, the energy supply devices should be of as compact and manageable a design as possible to enable just such power tools to be made available. The object on which the present invention is based is that of overcoming the above-described defects and disadvantages of the prior art and of providing an energy supply device, in particular for a power tool, which is of particularly compact and manageable design. In addition, it is an object of the present invention to specify a robust energy supply device which reliably withstands thermal stresses. Those skilled in the art would also welcome it if the invention could improve the dissipation of heat from the cells to their surroundings or the cooling capacity of the cells or of the energy supply device. It is a further object of the invention to provide an energy supply device with which, in particular, high discharge currents to a power tool can be made possible. In addition, the intention is to specify a power tool having a corresponding energy supply device, wherein the power tool is likewise to be of particularly compact and manageable design.

An energy supply device, in particular for a power tool, is provided, wherein the energy supply device comprises at least one cell and wherein at least one cell of the energy supply device has no pressure relief valve. In the context of the invention, this preferably means that the cell of the energy supply device does not have a pressure relief valve if the energy supply device comprises exactly one cell. In the context of the invention, however, it is preferred that the energy supply device has more than one cell, for example six, twelve or eighteen cells. In this case, at least one cell of the energy supply device has no pressure relief valve. In the context of the invention, it may however also be preferred that more than one cell has no pressure relief valve. In the context of the invention, it can also be preferred that none of the cells of the energy supply device has a pressure relief valve. The omission of at least one pressure relief valve preferably enables a particularly compact and manageable energy supply device to be provided. If none of the cells of the energy supply device has a pressure relief valve, an even more compact energy supply device can advantageously be provided. In this case, the energy supply device as a whole has no pressure relief valve.

By omitting a component which is activated only in very few exceptional situations, more chemically active energy supply material can be accommodated, while the volume of the energy supply device remains the same, and the energy density of the energy supply device can thereby be substantially increased. For example, it is possible with the invention and the omission of the pressure relief valves, to achieve energy densities which are approximately 5-10% higher than the energy densities of conventional energy supply devices of the kind known from the prior art. The energy density can be given, for example, in units of watt hours per liter (Wh/l), where the unit “liter” in this case describes the capacity measure or the volume which the energy supply device occupies. Preferably, at least one energy storage cell of the energy supply device can have an absolute volume of less than or equal to 150 ml. In the context of the invention, this preferably means that, in the context of the invention, an energy supply device is preferred whose energy storage cells have no pressure relief valves and in which the energy storage cells have a volume in a range of 150 ml or less. In the context of the invention, it is preferred that at least one energy storage cell of the energy supply device has an absolute volume of less than or equal to 150 ml. However, it may also be preferred for substantially all the energy storage cells of the energy supply device to have such a volume. In a very particularly preferred embodiment of the invention, at least one energy storage cell of the energy supply device has an absolute volume of less than or equal to 150 ml, wherein the corresponding energy storage cell has no pressure relief valve. In addition, it is particularly preferred for the at least one energy storage cell to have an internal resistance DCR_I of less than 10 milliohms (mohm). According to one exemplary embodiment of the invention, the energy supply device has at least one energy storage cell with an absolute volume of less than or equal to 150 ml, wherein the energy storage cell has no pressure relief valve but an internal resistance DCR_I of less than 10 milliohms.

Moreover, by omitting the pressure relief valves it is possible to reduce the production costs of the energy supply devices. The function of the pressure relief valve can be assumed, for example, by an electronic system of the energy supply device. In this way, it is possible to save installation space without sacrificing the function of the pressure relief valve and the associated operational safety.

In the context of the invention, it is preferred that at least one cell of the energy supply device has a flexible outer shell, at least in some section or sections or some region or regions. By means of the flexible outer shell, the at least one cell of the proposed energy supply device is designed to “breathe”, i.e. to follow any changes in the volume of the interior of the cell. It is thereby advantageously possible to avoid unwanted eruptive bursting of the cells within the energy supply device. Tests have shown that heat dissipation from the cells through the flexible outer shell and the changes in the volume of the cell which are possible as a result can be substantially improved. It has also been found that energy supply devices in which the cells have a flexible outer shell at least in some section or sections or some region or regions are suitable particularly for use in those power tools which have a high power requirement and therefore require a high discharge current.

Tests have shown that a combination of cells without a pressure relief valve but with a flexible outer shell in some section or sections or some region or regions has particularly advantageous thermal properties and can be cooled particularly well. In addition, energy supply devices with such flexible cells without a CID have a particularly high power density in comparison with conventional energy supply devices, thus making it possible to provide particularly high-performance energy supply devices which are particularly well suited to use in power tools with which power-intensive applications are carried out. The improvements in thermal properties and in power density in the case of cells with a flexible outer shell and without a pressure relief valve exceed the expectations that would have been justified by the individual measures (“flexible outer shell” or “no pressure relief valve”).

In the context of the invention, it is preferred that the at least one cell has an outer surface, wherein a size of the outer surface can be changed in accordance with cell parameters. The outer surface of the cell can preferably be formed by its outer walls. In the context of the invention, there may be a preference for the at least one cell to have a substantially cylindrical or cuboidal basic shape. If the cell has a substantially cylindrical basic shape, the outer surface of the cell can be formed, for example, by the envelope surrounding the cylindrical basic shape. A bottom side and/or a top side of the cell can also be counted as part of the outer surface of the cell. In the context of the invention, it is preferred that the top side and the bottom side of the cell preferably run parallel to one another and are arranged on opposite sides of the preferably cylindrically shaped cell.

If the cell has a cuboidal basic shape, the cell can be surrounded by preferably six outer walls, two side faces of the cuboid each being formed parallel to one another and preferably being located on opposite sides of the preferably cuboidal cell. For example, a cell with a substantially cuboidal basic shape can have opposite top and bottom sides, opposite side faces and opposite front and rear sides. The term “substantially” is not an unclear term for a person skilled in the art since a person skilled in the art knows that the cell can have, for example, rounded edges or corners without a cell which is, for example, cuboidal with rounded corners or edges losing its “substantially cuboidal shape” as a result. The same applies analogously to “substantially cylindrical cells”, which can likewise have rounded edges or corners without losing their cylindrical appearance.

In the context of the invention, the expression that the cell has “a flexible outer shell at least in some section or sections or some region or regions” preferably means that the cell is completely or partially surrounded by a flexible outer material. For example, individual outer walls or outer surfaces of the cell can be designed to be flexible or to comprise an elastic material. If the cell has a substantially cylindrical basic shape, the hollow-cylindrical outer wall of the cell can, for example, be of flexible design or be formed by a flexible, preferably elastic, material, while the top and bottom sides of the cell are formed, for example, from a solid and/or rigid material. If the cell has a cuboidal basic shape, individual side faces, such as the top or bottom side or a side wall or a plurality of side walls, for example, can be of flexible design or can be formed by a flexible, preferably elastic, material. In the context of the invention, there may also be a preference for subsections or subregions of individual outer wall surfaces of the cell to be of flexible design or to be formed by a flexible, preferably elastic, material. In the context of the invention, there may furthermore be a preference for the cell to be completely surrounded by a flexible outer shell, wherein the flexible outer shell is preferably formed by a flexible, preferably elastic, material.

If the size of the outer surface of the cell changes in accordance with cell parameters, the flexible regions, sections and/or surfaces of the cell, in particular, can preferably change their shape or their extent. For example, the cell can expand its volume substantially uniformly in all spatial directions. This may be the case, for example, if the cell is formed substantially completely by a flexible material. If the cell is formed partially by a flexible material, there may be a preference in the context of the invention for the cell to expand only in one or two spatial directions or for the expansion of the cell to take place nonuniformly in the different spatial directions. In the proposed energy supply device, there is preferably a relationship between the configuration of the cell in respect of the arrangement of the flexible material and the ability of the cell to expand. In other words, the cell can expand in a manner dependent on a distribution and/or arrangement of flexible regions or flexible material in the region of the outer shell of the cell. In the proposed energy supply device, it is preferably also possible for a volume of the at least one cell to change.

The change in the outer surface and/or the volume of the at least one cell can advantageously improve the thermal behavior or robustness of the cell or of the energy supply device. In particular, the increase in the volume and/or outer surface of the cell allows more heat to be dissipated to the surroundings of the cell, thus enabling the cell to be cooled better. The heat can be dissipated by radiation and/or convection, for example.

For example, the volume and/or the outer surface of the cell can change if the temperature and/or the pressure within the cell change. In the context of the invention, there may be a preference for the outer surface and/or the volume of the cell to increase when the temperature in an interior of the at least one cell increases. As an alternative or in addition, there may be a preference for the outer surface and/or the volume to increase when the pressure in an interior of the at least one cell increases. Similarly, the volume and/or the outer surface can decrease if the temperature and/or the pressure within the cell decrease/s. In the context of the invention, it is preferred that the high discharge currents which flow during operation of a power tool to which the proposed energy supply device can be connected can lead to an increase in the temperature inside the at least one cell of the energy supply device. The elevated temperatures can in turn lead to pressure changes within the cell, with temperature increases preferably leading to pressure increases and reduced temperatures to reduced pressures.

In addition to temperature and/or pressure changes, chemical reactions or chemical processes can also lead to changes in the volume and/or the outer surface of the cell. In the context of the invention, such chemical reactions or processes are referred to as “chemical parameters”, in accordance with which the outer surface and/or the volume of the cell can change by virtue of its flexible outer structure. Preferably, the cell parameters, in accordance with which the volume and/or the lateral surface of the at least one cell change/s, can be selected from a group comprising temperature, pressure and/or chemical parameters, without being limited thereto.

In the context of the invention, it is preferred that the volume of the at least one cell with flexible outer shell changes in the course of its life. The volume of the at least one cell preferably increases with each discharge process. The corresponding increase in the volume of the at least one cell can be in a range of 10%, for example, in the case of 500 charge and discharge cycles. In the context of the invention, this preferably means that the at least one cell has a volume in a new state wherein the new volume can be assigned a percentage of 100%. After performing 500 charge and discharge cycles in accordance with the above example, the at least one cell may then have a changed volume of about 110% of the original volume in the new state.

In the context of the invention, it is preferred that the outer surface of the at least one cell can be changed in a range of +/−12%, preferably in a range of +/−8%, and particularly preferably in a range of +/−5%, with respect to a reference outer surface. Similarly, there may be a preference for the volume of the cell to change in a range of +/−12%, preferably in a range of +/−8%, and particularly preferably in a range of +/−5%, with respect to a reference volume.

A possible reference outer surface can be the outer surface of the at least one cell in the cold state, that is to say, for example, at room temperature, it being possible for the room temperature to be, for example, 20° C. Similarly, a possible reference volume can be the volume of the at least one cell in the cold state or at room temperature. It is also possible, for example, to use a cell in the new state or in an unaged state as a reference source. These new state data are usually known and laid down in writing, thus enabling them to be stored in the energy supply device, for example. In the context of the invention, however, there may also be a preference for the use of a different reference outer surface or a different reference volume or for carrying out measurements with a suitable sensor system before and/or during use of the energy supply devices, in order to obtain up-to-date reference values. Possible reference values for the outer surface and/or the volume can preferably be stored in a control device and/or in an electronic control system of the energy supply device and/or of the power tool.

In the context of the invention, it is preferred that the flexible outer shell comprises an elastic material. The flexible outer shell can comprise aluminum or be formed from aluminum, for example. Aluminum alloys, as alloys which contain a proportion of aluminum, can also be used as elastic material to form the flexible outer shell.

The invention advantageously allows the provision of an energy supply device having at least one cell which exhibits reduced heating or improved cooling capacity and which is therefore particularly well suited to supplying power tools in which high power levels and high currents, preferably constant currents, are desired for operation. In particular, the invention can be used to provide an energy supply device for a power tool in which the heat that may be generated during operation of the power tool and when outputting electrical energy to the power tool can be dissipated in a particularly simple and uncomplicated manner. The invention can advantageously be used to provide an energy supply device which can supply electrical energy in an optimum manner primarily also to power tools which have stringent requirements in respect of power and discharge current. In other words, the invention can provide an energy supply device for particularly powerful power tools with which heavy drilling or demolition work can be performed on construction sites for example.

In the context of the invention, the term “power tool” is to be understood as meaning a typical piece of equipment that can be used on a construction site, for example a building construction site and/or a civil engineering construction site. These may be hammer drills, chisels, core drills, angle or cut-off grinders, cutting devices or the like, without being restricted thereto. In addition, auxiliary devices such as those occasionally used on construction sites, such as lamps, radios, vacuum cleaners, measuring devices, construction robots, wheelbarrows, transport devices, feed devices or other auxiliary devices, can be “power tools” in the context of the invention. The power tool can in particular be a mobile power tool, the proposed energy supply device in particular also being able to be used in stationary power tools, such as rig-mounted drills or circular saws. However, preference is given to hand-held power tools that are, in particular, operated using a storage battery or battery.

It is preferred in the context of the invention that the at least one cell has a temperature cooling half-life of less than 12 minutes, preferably less than 10 minutes, particularly preferably less than 8 minutes. In the context of the invention, this preferably means that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say connected to a power tool. In particular, energy supply devices with temperature cooling half-lives of less than 8 minutes have been found to be particularly suitable for use with high-powered power tools. The temperature cooling half-life can of course also have a value of 8.5 minutes, 9 minutes 20 seconds or of 11 minutes 47 seconds.

Owing to the surprisingly low temperature cooling half-life of the proposed energy supply device, the heat generated during operation of the power tool or when it is charging remains within the energy supply device only for a short time and cannot do any major thermal damage in this way. Moreover, the thermal loading on the components of the energy supply device or the power tool having the proposed energy supply device can be considerably reduced. As a result, the energy supply device can be preserved and its service life extended.

In the context of the invention, there is a preference for the at least one cell to be arranged in a battery pack of the energy supply device. A series of individual cells can preferably be combined in the battery pack and in this way inserted into the energy supply device in an optimum manner. For example, 5, 6 or 10 cells can form a battery pack, with integer multiples of these numbers also being possible. For example, the energy supply device can have individual cell rows which may comprise, for example, 5, 6 or 10 cells. An energy supply device having, for example, three rows of five cells may comprise, for example, 15 individual cells.

The energy supply device is preferably configured to provide a discharge current of at least 20 A for at least 10 s. For example, the energy supply device may be designed to provide a discharge current of at least 20 A, in particular at least 25 A, for at least 10 s. In other words, the storage battery can be configured to provide a continuous current of at least 20 A, in particular at least 25 A.

It is also conceivable that peak currents, in particular short-term peak currents, may lead to intense heating of the storage battery. Therefore, a storage battery with powerful cooling, as can be achieved by the measures described here, is particularly advantageous. It is conceivable, for example, that the storage battery can provide at least 50 A for 1 second. In other words, it is preferred in the context of the invention that the energy supply device is configured to provide a discharge current of at least 50 A for at least 1 s. Power tools can often require high levels of power for short time periods. An energy supply device capable of delivering such a peak current and/or such a continuous current may therefore be particularly suitable for high-powered power tools such as those used on construction sites.

It is preferred in the context of the invention for the at least one cell to comprise an electrolyte, wherein the electrolyte is preferably present in a liquid state of aggregation at room temperature. The electrolyte can comprise lithium, sodium and/or magnesium, without being restricted thereto. In particular, the electrolyte can be lithium-based. As an alternative or in addition, said electrolyte can also be sodium-based. It is also conceivable for the rechargeable battery to be magnesium-based. The electrolyte-based energy supply device may have a rated voltage of at least 20 V, in particular of at least 28 V, for example 36 V. A rated voltage in a range of from 18 to 22 V, in particular in a range of from 21 to 22 V, is very particularly preferred. The at least one cell of the energy supply device can have, for example, a voltage of 3.6 V, without being restricted thereto. It is preferred in the context of the invention for the energy supply device to be charged, for example, at a charging rate of 1.5 C, preferably 2 C and most preferably 3 C. A charging rate of xC can be understood as meaning the current intensity which is required to fully charge a discharged energy supply device in a fraction of an hour corresponding to the numerical value x of the charging rate x C. For example, a charging rate of 3 C allows the storage battery to be fully charged within 20 minutes.

In order to avoid overheating of the storage battery, provision can be made for the charging rate to be reduced and/or the charging process to be interrupted when the temperature reaches or exceeds a limit temperature. The limit temperature can be, for example, between 70° C. and 95° C., in particular 80° C. The charging rate can be reduced to 1 C or less. For example, it can be reduced to a maximum of 0.5 C. The reduction of the charging rate or the interruption of the charging process can take place for a certain period of time.

In the context of the invention, there is a preference for the at least one cell of the energy supply device to have a surface A and a volume V, wherein a ratio A/V of surface to volume is greater than eight times the inverse of the cube root of the volume. The expression that the surface A of the at least one cell is greater than eight times the cube root of the square of the volume V can preferably also be expressed by the formula

A>8*V\hat{ }(⅔).

In the context of the invention, there may also be a preference for the ratio A/V of surface to volume to be greater than ten times the inverse of the cube root of the volume.

It has been found that energy supply devices whose cells satisfy the stated relationship can be cooled significantly more effectively than previously known energy supply devices having, for example, cylindrical cells. The above relationship can be satisfied, for example, by virtue of the fact that, although the cells of the proposed energy supply device have a cylindrical basic shape, additional surface-area-enlarging elements are arranged on the surface thereof. Said elements can be, for example, fins, teeth or the like. Cells which do not have a cylindrical basic shape, but rather are shaped entirely differently, can also be used within the scope of the invention. For example, the cells of the proposed energy supply device can have a substantially cuboidal or cube-like basic shape. The term “substantially” is not unclear to a person skilled in the art here because a person skilled in the art knows that, for example, a cuboid with indentations or rounded corners and/or edges should also be covered by the term “substantially cuboidal” in the context of the present invention.

It is preferred in the context of the invention for the at least one cell to have an internal resistance DCR_I of less than 10 milliohms (mohm). In preferred embodiments of the invention, the internal resistance DCR_I of the at least one cell can be less than 8 milliohms and preferably less than 6 milliohms. Here, the internal resistance DCR_I is preferably measured in accordance with standard IEC61960. The internal resistance DCR_I represents, in particular, the resistance of a cell of the energy supply device, wherein any components or accessories of the cell do not make any contribution to the internal resistance DCR_I. A low internal resistance DCR_I is advantageous, as this means that unwanted heat that needs to be dissipated does not arise at all. The internal resistance DCR_I is, in particular, a DC resistance which can be measured in the interior of a cell of the proposed energy supply device. The internal resistance DCR_I can of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, it is possible to provide an energy supply device which has particularly good thermal properties in the sense that it can be operated particularly well at low temperatures, wherein the expenditure on cooling can be kept surprisingly low. In particular, the proposed energy supply device is particularly well suited to supplying electrical energy to particularly powerful power tools. The proposed energy supply device can therefore make a valuable contribution to allowing use of storage battery-operated power tools even in areas of application that those skilled in the art previously assumed were not accessible to storage battery-operated power tools.

In a second aspect, the invention relates to a power tool having a proposed energy supply device. The terms, definitions and technical advantages introduced for the energy supply device preferably apply in an analogous manner to the power tool.

### BRIEF DESCRIPTION OF THE DRAWINGS

Further advantages will become apparent from the following description of the figures. The figure, the description and the claims contain numerous features in combination. A person skilled in the art will expediently also consider the features individually and combine them to form useful further combinations.

Identical and similar components are denoted by the same reference signs in the figure, in which:

FIG. 1 shows a schematic view of a preferred embodiment of the energy supply device

FIG. 2 shows a schematic view of a preferred embodiment of the power tool

FIG. 3 shows the prior art: schematic view of an energy supply device with a cell having a pressure relief valve

FIG. 4 schematically shows a comparison of cells which are known from the prior art with cells without a pressure relief valve.

### DETAILED DESCRIPTION

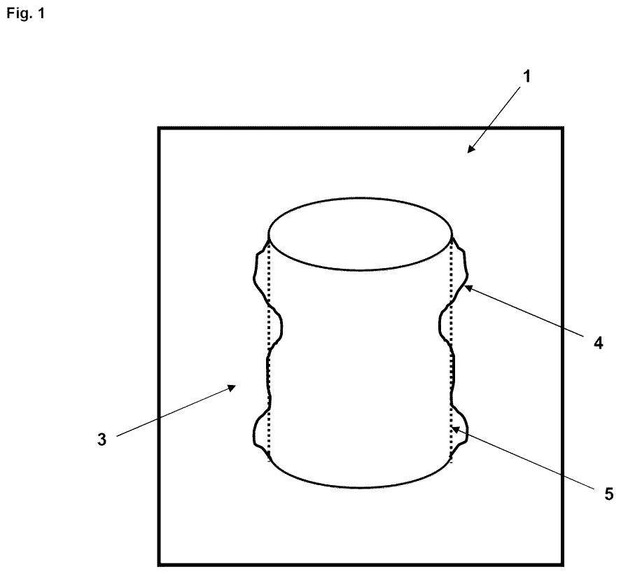

FIG. 1 shows a schematic view of a preferred embodiment of the energy supply device 1. For the sake of clarity, the energy supply device 1 illustrated in FIG. 1 has exactly one cell 3, it being possible for energy supply devices 1 according to the invention to have six, twelve or eighteen cells 3, for example, without being restricted thereto. The cell 3 depicted in FIG. 1 is a cell 3 with a substantially cylindrical basic shape. The cell 3 has a top side and a bottom side, wherein the top side and the bottom side run substantially parallel to one another and are arranged on opposite sides of the cell 3 (“top” and “bottom”). In addition to the top and the bottom side, the cell 3 shown in FIG. 1 has an outer wall, which is formed by a hollow cylinder. This outer wall can form, for example, an outer surface of the cell 3. In the exemplary embodiment of the invention illustrated in FIG. 1, the volume of the cell is enclosed by the hollow-cylindrical outer wall, as well as by the top side and the bottom side of the cell 3. The cell 3 which is illustrated in FIG. 1 does not have a pressure relief valve 6.

The cell 3 illustrated in FIG. 1 has a flexible outer shell 4, the flexible outer shell 4 of the cell 3 depicted in FIG. 1 being arranged in particular in the region of the outer surface of the cell 3. In other words, it is in particular the outer surface of the cell 3 which has the flexible outer shell 4. In the example of the cell 3 depicted in FIG. 1, the top and bottom sides are formed from a rigid and/or solid material.

In the cold state, the cell 3 can occupy a minimum volume or have a minimum outer surface. This volume or this outer surface in the cold state can be used as reference volume 5 or as reference outer surface 5 in order to indicate changes in the flexible outer shell 4 compared with a cell 3 in the cold state.

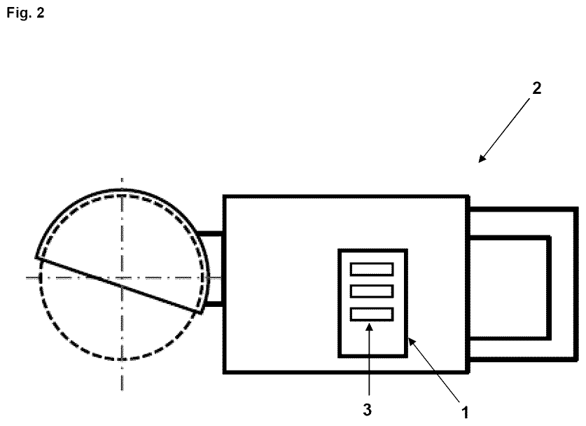

FIG. 2 shows a schematic view of a preferred embodiment of the power tool 2 with a proposed energy supply device 1. The energy supply device 1 illustrated in FIG. 2 has, for example, three cells 3, the flexible outer shell 4 of the cell 3 not being illustrated in FIG. 2. The power tool 2 can be a cut-off grinder, for example, which has a cutting disk as a tool. The power tool 2 can have a grip which is designed, for example, as a rear handle. In addition, the power tool 2 can have control elements, such as switches or buttons, in a manner known per se. Moreover, the power tool 2 can have a motor, which can represent a load and can be supplied with electrical energy by the energy supply device 1. None of the cells 3 illustrated in FIG. 2 has a pressure relief valve 6.

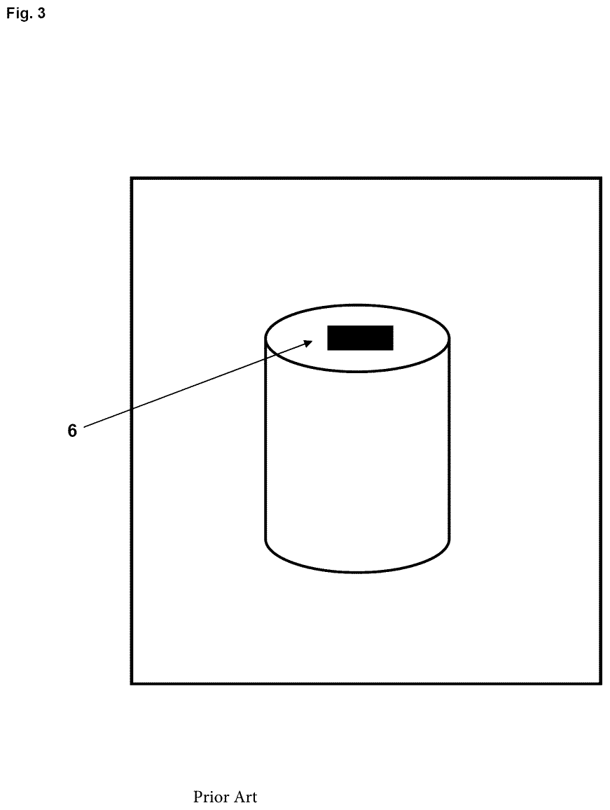

FIG. 3 shows an energy supply device of the kind known from the prior art. The cell of the energy supply device has a rigid, solid outer structure. A pressure relief valve 6 as a component of the cell is depicted on the top side of the cell. FIG. 3 shows an energy supply device which is not designed according to the invention.

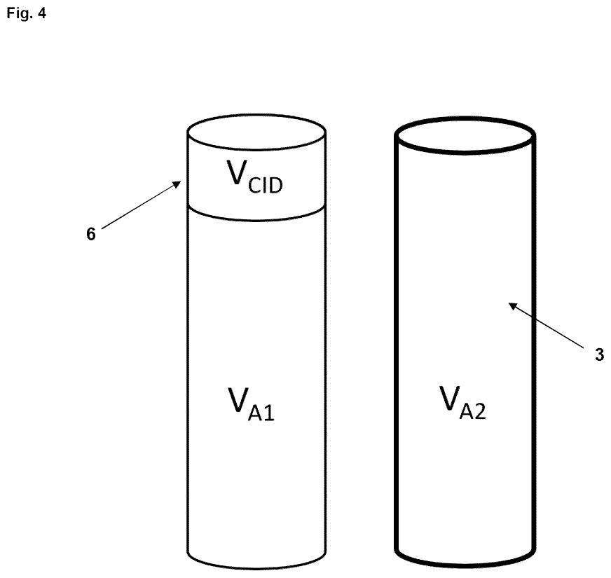

FIG. 4 shows a schematic illustration of a comparison of cells which are known from the prior art with cells 3 without a pressure relief valve 6. The left side of FIG. 4 depicts a cylindrical cell from the prior art which has a pressure relief valve 6 in its upper region. By virtue of the presence of the pressure relief valve 6, the filling space V_{A1} which is available for chemically active material is reduced by the volume V_{CID}, while the total cell volume remains the same. The right-hand side of FIG. 4 depicts schematically a preferred embodiment of the proposed cell 3 without a pressure relief valve 6. Here, the filling space V_{A2} which is available for chemically active material represents the sum of the filling chamber V_{A1} which is available for chemically active material in conventional cells and the volume V_{CID} which is occupied by the pressure relief valve 6. As can be seen from FIG. 4, the volume V_{A2} which is available for chemically active material according to the invention is significantly greater than the volume V_{A1} which is available for chemically active material in conventional cells. The reason for this is the omission of the pressure relief valve 6 and the replacement of its function by electronic means.

### LIST OF REFERENCE SIGNS

1 Energy supply device
2 Power tool
3 Cell
4 Flexible outer shell
5 Reference outer surface or reference volume of the cell
6 Pressure relief valve

What is claimed is:

1-13. (canceled)

14. An energy supply device for a power tool, the energy supply device comprising:
at least one cell, the at least one cell of the energy supply device having no pressure relief valve.

15. The energy supply device as recited in claim 14 wherein the at least one cell has a flexible outer shell, at least in some section.

16. The energy supply device as recited in claim 14 wherein the at least one cell has an outer surface, wherein a size of the outer surface can be changed in accordance with at least one cell parameter.

17. The energy supply device as recited in claim 14 wherein the at least one cell has a volume, wherein a size of the volume can be changed in accordance with at least one cell parameter.

18. The energy supply device as recited in claim 16 wherein the at least one cell parameter is selected from the group consisting of temperature, pressure and chemical parameters.

19. The energy supply device as recited in claim 16 wherein the outer surface of the at least one cell is changeable in a range of +/−12% with respect to a reference outer surface.

20. The energy supply device as recited in claim 16 wherein the outer surface of the at least one cell is changeable in in a range of +/−8% with respect to a reference outer surface.

21. The energy supply device as recited in claim 16 wherein the outer surface of the at least one cell is changeable in a range of +/−5% with respect to a reference outer surface.

22. The energy supply device as recited in claim 17 wherein the at least one cell parameter is selected from the group consisting of temperature, pressure and chemical parameters.

23. The energy supply device as recited in claim 17 wherein the volume of the at least one cell is changeable in a range of +/−12% with respect to a reference volume.

24. The energy supply device as recited in claim 17 wherein the volume of the at least one cell is changeable in a range of +/−8% with respect to a reference volume.

25. The energy supply device as recited in claim 17 wherein the volume of the at least one cell is changeable in a range of +/−5% with respect to a reference volume.

26. The energy supply device as recited in claim 14 wherein the flexible outer shell comprises an elastic material.

27. The energy supply device as recited in claim 14 wherein the at least one cell has a cylindrical or cuboidal basic shape.

28. The energy supply device as recited in claim 14 wherein the at least one cell has a surface A and a volume V, wherein a ratio A/V of surface to volume is greater than eight times the inverse of the cube root of the volume.

29. The energy supply device as recited in claim 14 wherein the at least one cell has a cell core, wherein no point within the cell core is more than 5 mm away from a surface of the energy supply device.

30. The energy supply device as recited in claim 14 wherein the cell/energy supply device has an internal resistance DCR_I of less than 10 milliohms.

31. The energy supply device as recited in claim 14 wherein the cell/energy supply device has an internal resistance DCR_I of less than 8 milliohms.

32. The energy supply device as recited in claim 14 wherein the cell/energy supply device has an internal resistance DCR_I of less than 6 milliohms.

33. A power tool comprising the energy supply device as recited in claim 14.
